(19) United States
(12) Patent Application Publication
(10) Pub. No.: US 2004/0174520 A1
(43) Pub. Date: Sep. 9, 2004

(54) Low resolution surface enhanced raman spectroscopy on sol-gel substrates

(76) Inventors: W Ranjith Premasiri, Weymouth, MA (US); Richard H Clarke, Boston, MA (US); M Edward Womble, Watertown, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/484,796

(22) PCT Filed: Jul. 23, 2002
(86) PCT No.: PCT/US02/23459

Related U.S. Application Data
(60) Provisional application No. 60/307,299, filed on Jul. 23, 2001.

(30) Foreign Application Priority Data
Jul. 17, 2001 (GB) 0117396.2

(51) Int. Cl. G01J 3/44

(52) U.S. Cl. 356/301

(57) ABSTRACT

The invention is directed to a method of making and using a porous solid matrix for trapping metal nanoparticles for use in detection, identification and quantification of trace levels of water contaminants using surface enhanced Raman scattering (SERS). The metal nanoparticles are polydispersed in the porous solid matrix, sufficiently separated to prevent conduction, in creating a broad area of excited electrons in response to applied radiation. In one aspect, the metal nanoparticles may be derived from gold, silver or platinum. In another aspect, the porous solid matrix is a sol-gel embedded with a polydispersion of metal for use in SERS detection. This metal nanoparticle substrate can be used on-site, is highly sensitive and easy to use for an immediate and accurate result.

### CROSS REFERENCE TO RELATED APPLICATIONS

This application claims the benefit under 35 U.S.C. §119(e) of U.S. Provisional Patent Application No. 60/307,299 filed on Jul. 23, 2001, entitled LOW RESOLUTION SURFACE ENHANCED RAMAN SPECTROSCOPY ON SOL-GEL SUBSTRATES, the whole of which is hereby incorporated by reference herein.

### STATEMENT REGARDING FEDERALLY SPONSORED RESEARCH OR DEVELOPMENT

Part of the work leading to this invention was carried out with United States Government support provided under a grant from the Department of Defense, Army Research Office, Contract Nos. DAAD17-99-2-0070 and DAAM01-97-C-0006. Therefore, the U.S. Government has certain rights in this invention.

### BACKGROUND OF THE INVENTION

Concern for contamination of water has increased tremendously with the advent of increased awareness of environmental issues, drinking supply issues and terrorism. For example, contamination of wastewater by cyanide, among other contaminants or trace components such as phosphonates or thiols, has motivated widespread concern over leakage of this harmful compound into large water bodies. The gold mining industry uses more than 100 million pounds of cyanide salt annually in the United States alone. Cyanide salts are also used in other industries such as electroplating, photographic development, printing, textiles, and leather manufacturing. The United States Environmental Protection Agency currently requires that the residual cyanide in treated (i.e. detoxified) industrial wastewater be less than 1 ppm before such wastes are allowed to be discharged into aquatic ecosystems¹. Therefore, the development of high sensitive sensors that could continually monitor industrial wastewater on site for trace quantities of contaminants, e.g., cyanide, phosphonates, or thiols, is of considerable interest.

A sensor for estimating cyanide concentration in the factory drain has been developed using lipid membranes². This method requires significant pretreatment time and/or pH adjustment. Its relatively high detection limit, (about 3 ppm) indirect detection, and long measurement time (about 5 minutes) make the sensor not very attractive. A fluorometric cyanide sensor has been described using Cu⁺² and a fluorescent dye³ for continuous flow detection. The measurements are made on the fluorescent signal reduction from the interaction of cyanide with Cu⁺². This indirect optochemical method is susceptible to chemical interference factors and flow variables.

Other methods found in the literature include a tape coated with a Cu⁺²-chemical complex to monitor hydrogen cyanide in air⁴ and amperometric methods using enzyme inhibition electrodes to detect low-level cyanide in watery^{5,6}. The electrochemical methods claim detection limits less than 1 ppm. Gas chromatography methods have also been used for cyanide detection in serum and rumen fluid of cattle⁷.

The military currently uses a system called the M272 Chemical Agent Detection Kit, which does not meet current water monitoring standards. The M272 test procedures require 30-40 minutes to complete and are difficult to perform while wearing chemical protective clothing. The M272 cannot detect chemical contaminants at the required levels to ensure treated water supplies meet the Tri-Service field drinking water standards nor at concentrations necessary to accurately forecast water purification equipment performance. Table 1 lists the detection requirements for exemplary chemical agents in μg/L of water for water consumption rates of 5 L/day and 15 L/day. Also listed are the current capabilities of the M272. As shown in Table 1, the M272 underscores the sensitivity required to detect such chemical contaminants.

TABLE 1
DOD Tri-Services Field Water Quality Standards (μg/L)

| | Water Consumption | | Sensitivity |
|---|---|---|---|
| CW Agent | 5 L/day | 15 L/day | M272 |
| Nerve Agent | | | 20 |
| VX (methylphosphonothioic acid) | 15 | 5 | |
| GD (Soman) | 12 | 4 | |
| GB (Sarin) | 28 | 9.3 | |
| GA (Tabun) | 140 | 46 | |
| Hydrogen Cyanide | 6,000 | 2,000 | 20,000 |
| Sulfur Mustard | 140 | 47 | 2,000 |

Based on the foregoing, a more direct approach for the detection, identification and quantification of chemical agents in water that is highly sensitive, easy to use and cost effective would be advantageous.

### BRIEF SUMMARY OF THE INVENTION

With Surface Enhanced Raman Spectroscopy (SERS), two properties make it particularly well suited to measuring organic contaminants against a water background. First, similar to traditional mid-infrared spectroscopy, Raman spectroscopy uses the characteristic vibrational features of the contaminants to provide their identity. However, Raman uses inelastic light scattering, instead of transmitting light through the sample. Second, unlike traditional infrared spectroscopy in which the vibrational fingerprint region used for identifying organic contaminants is masked by the strong infrared absorbance of water, Raman scattering is unaffected by the presence of the water background and reports only the contaminant sample. The present invention overcomes the downside to Raman Spectroscopy due to its relatively inefficient scattering and subsequent weakness of the Raman signal.

The invention is directed to a chemical process for making and using a porous solid matrix for trapping metal nanoparticles for use in detection, identification and quantification of water contaminants using Raman Spectroscopy. The metal nanoparticles are in-situ self-embedded in the porous matrix, polydispersed, sufficiently separated to prevent conduction, in creating a broad area of excited electrons in response to applied radiation. In one aspect of the invention, the metal nanoparticle-embedded substrate may be made by neutralizing the metal from, e.g., gold, silver or platinum salts in a porous silicate matrix. In another aspect of the invention, the metal nanoparticle-embedded substrate may include optical filtering, but are not limited to SERS. In yet another aspect of the invention, the porous silicate matrix is a sol-gel embedded with an appropriate metal nanoparticles for use in surface enhanced Raman scattering detection.

The substrate of the invention is highly sensitive, easy to use and may be disposable. It is usable in a significantly large temperature window, applicable to a wide range of pH enabling it to be used on-site for an immediate and accurate result.

### BRIEF DESCRIPTION OF THE FIGURES

Other features and advantages of the invention will be apparent from the following description of the preferred embodiments thereof and from the claims, taken in conjunction with the accompanying drawings, in which:

FIGS. 1A and 1B show surface enhanced Raman scattering effects of using the metal nanoparticle-embedded glassy matrix of the invention with (1A) and without (1B) an exemplary contaminant, cyanide. λν₀ is wavelength of laser light, λν₁ is stokes line or Raman scattering laser light and λν₋₁ is anti-stokes line;

FIG. 2 shows an ultraviolet-visible spectrum of the gold sol-gel made according to the method of the invention;

FIG. 3 shows surface enhanced Raman spectra of sodium cyanide (NaCN), in different concentrations, on the gold sol-gel made according to the method of the invention;

FIG. 4 shows a calibration curve for NaCN in water on the gold sol-gel made according to the method of the invention;

FIG. 5 shows surface enhance Raman scattering spectrum of 50 ppb methyl phosphonic acid (MPA) using the gold sol-gel made according to the method of the invention;

FIG. 6 shows the calibration curve for MPA in water at a 20 second interval time;

FIG. 7 shows surface enhance Raman scattering spectrum of the chemical agent Tabun (GA) in water using the gold sol-gel made according to the method of the invention;

FIG. 8 illustrates an exemplary system for using the invention in contaminant detection; and

FIG. 9 is a chemical reaction forming a sol-gel and an exemplary gold ion reduction.

### DETAILED DESCRIPTION OF THE INVENTION

The invention comprises a direct approach using a vibrational spectroscopic method for direct estimation of trace levels of water contaminants. In particular, the invention comprises a porous solid-state substrate embedded with metal particles for use in Surface Enhanced Raman Spectroscopy (SERS).

The SERS method, discovered in 1970s⁸⁻¹¹, depends upon a potentially large enhancement in the effective Raman cross section of species to be detected when located at or very close to certain roughened metal surfaces or colloidal metal particles. The SERS effect has been explained by two popular theories: (1) the electromagnetic theory, wherein the local electromagnetic field at the metal substrate is enhanced from the incident radiation field, due to generation of surface plasmons and (2) the chemical theory, which propounds a chemical interaction between the analyte and the substrate, through bond formation or charge transfer, resulting in the increase in polarizability of the molecule^{11,12}. SERS signal amplifications are normally very high, often ˜10⁶ or higher, allowing measurable vibrational spectra of chemical species with short integration time and/or without background subtraction. The most commonly used metal substrates are the coinage metals, e.g., copper, silver, and gold. These metals exhibit surface plasmons that can be excited by visible light when the surface provides a curved structure on the scale of 10-100 nm, such as gratings, spheres or roughened metal surface^{11,12}.

Raman spectroscopy relates to the scattering of light by a gas, liquid or solid with a species characteristic shift in frequency or wavelength from that of the usually monochromatic incident radiation. Upon irradiation of a molecule with light in biological applications, the incident radiation having a frequency ν should produce scattered radiation, the most intense part of which has unchanged frequency (Rayleigh scattering). In addition, if the polarization of a molecule changes as it rotates or vibrates, there are spectral lines of much lesser intensity at frequencies ν±ν_{K}, where ν_{K} is the molecular frequencies of rotation or vibration.

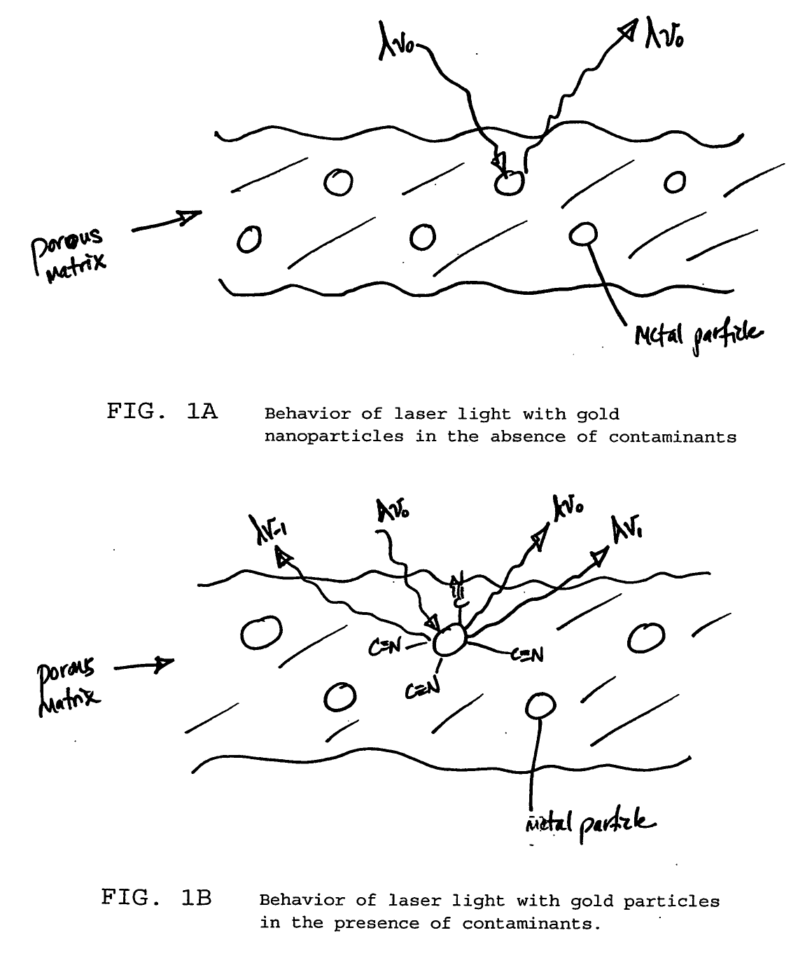

The chemical theory of SERS pertains to a vibrational spectroscopy for characterizing and for determining the chemical structure of molecules. This theory is associated with the overlap of metal and adsorbate electronic wave functions, which leads to ground-state and light-induced charge-transfer processes. As shown in FIGS. 1A and 1B, a scattering of light passes through a substrate where the light changes in frequency and with a random alteration in phase. In the charge-transfer model, an electron of the metal, excited by the incident photon, tunnels into a charge-transfer excited state of the absorbed molecule. The resulting negative ion (adsorbate molecule-electron) has a different wavelength than the original neutral adsorbate molecule. Therefore, the charge-transfer process induces a nuclear relaxation in the adsorbate molecule which, after the return of the electron to the metal, leads to a vibrationally excited neutral molecule and to emission of a Raman-shifted photon generating a particular wavelength characteristic of the structure of the molecule.

An exemplary SERS substrate of the invention is highly sensitive to cyanide, convenient and easy to use in aqueous media, and potentially disposable. This detection substrate is produced by making a polydispersion of metal particles in a porous silicate matrix (a sol-gel). The polydispersion of metal particles must be sufficient enough to prevent conduction and to increase participation in light induced excited electron decay. The metal particles are reduced from their salts generating about 60-80 nm in diameter polydispersed into the porous solid matrix. The polydispersion of metal particles should allow for contaminants to be in touch with the metal particles. The porous nature of the sol-gel allows for molecules and ions to penetrate into the matrix and interact with the metal substrate when immersed in an analyte solution. With a focused laser beam, the stable gel may be immersed directly into the solution to make continuous SERS measurements.

While the preparation of sol-gel materials have been known for years¹³⁻¹⁶, the suspension of colloidal gold in the sol-gel that could be used for SERS is not straightforward. Gold colloids are usually prepared in water and are sensitive to many factors such as pH, ionic strength and temperature¹⁷. Some common methods used in preparing gold colloid in solid matrices include the following methods: the melt method^{18,19}, ion bombardment²⁰, r.f. sputtering²¹, and pyrolysis of precursor molecules in a sol-gel film^{22,23}. However, these methods are often expensive and time consuming.

The present invention describes a lower cost method of making sol-gel embedded with, e.g., colloidal gold. The method of the invention provides a metal-embedded substrate for a direct measurement of trace level of water contaminants, e.g., cyanide (˜10, ppb) using a highly sensitive and disposable SERS sol-gel substrate. For example, the colloidal gold in the matrix is highly stable and may be used at variable pH ranging from pH 1 to pH 9, at different ionic strength and temperature ranging from 0° C. to 100° C., preferably from 0° C. to 60° C.

In one aspect of the invention, the SERS substrate may be made using a suspension of silver nanoparticles in a sol-gel.

In another aspect of the invention, the SERS substrate may be made using as suspension of platinum nanoparticles in a sol-gel.

SERS has been widely applied to the study of cyanide in solution. Based on the studies of the present invention, the intensity of the most characteristic Raman band of cyanide, (˜2100 cm⁻¹) corresponding to the C≡N stretching frequency, becomes significantly enhanced when introduced onto a gold metal substrate.

In yet another aspect of the invention, the Raman spectroscopy for use with the metal-embedded substrate of the invention is a low-resolution surface enhanced Raman spectroscopy for the detection of water contaminants that is highly useful and cost effective. Typical SERS analyses have been carried out on spectrometers with high resolution capabilities, and the exact position of a cyanide peak, for example, or any shift in the peak from the conventional Raman position is of value in terms of the nature of interaction between the adsorbent and the substrate, providing insight into understanding the surface phenomenon and interfacial processes. However, for conventional analytical purposes, namely identification and quantification of the presence of contaminants in an aqueous sample, such high resolution SERS is not required. An instrument for the specific detection of cyanide in water would not demand high resolution, since the target frequency lies in an isolated, well-defined spectral region (˜2100 cm⁻¹), as long as there is no interference from nearby vibrational bands from other organic or inorganic contaminants in the sample. Such an instrument would require limited optical setup, making it portable and cost effective for on-site testing of samples.

In accordance with the invention, a method of manufacturing a low-resolution SERS substrate is made with an exemplary metal material such as, e.g., colloidal gold. Any appropriate metal may be used for the substrate of the invention. Other metals include, but are not limited to, silver and platinum. The metal nanoparticles may be derived from salts of those metals. Optimal metal salts should be soluble in water that gives a clear solution in water. The metal used must have no surface enhancing effect. The metal is derived from its salt that has acidic properties in water so that the chemical carrier of the metal can be bleached out.

Immobilized reagents are used in many important chemical processes like in separation science and in many catalytic processes. Sol-gel technology is one of unique ways that allows immobilization or encapsulation of chemical reagents, usually without any chemical modification to the immobilized species, under ambient processing conditions within a porous matrix. Sol-gels have many attractive characteristics like optical transparency (down to ˜300 nm), thermal stability, chemical inertness, and tunability of its pore size, surface area, and shape.

Making sol-gel is a three-step process: Hydrolysis, condensation and polycondensation. The metal alkoxide precursor, alcohol (as a co-solvent), water, and an acid (as the catalyst) are mixed. Hydrolysis is initiated, and the sensing reagent (e.g., gold, silver or platinum) can be added directly into the solution during this step. Next, condensation between an unhydrolyzed alkoxide group and a hydroxyl group or between hydroxyl sol particles and additional networking results in a porous, glasslike, three-dimensional lattice called the gel. The wet gel is then aged and dried to form a porous, transparent solid. The color of the solid depends on the encapsulated chemical agent.

The following examples are presented to illustrate the advantages of the present invention and to assist one of ordinary skill in making and using the same. These examples are not intended in any way otherwise to limit the scope of the disclosure.

### EXAMPLE I

Gold sol-gel substrates used in the present experiments were prepared as follows. The method was developed by modifying Zaitoun's sol-gel preparation²⁴. All water used in the experiments was purified using Millipore Simplicity-185. Tetramethoxy silane (Alfa Aeser 99.9%), 5 ml, was mixed with 2 ml of water, 1 ml of 1% HC1 (prepared using 37% HC1, Aldrich), and 12 ml of methanol (J. T. Baker, ACS grade) in a 100 ml Erlenmeyer flask. Ethanol may also be used instead of methanol. The flask was covered with paraffin film and the solution was stirred for about 4 hrs. About two drops of 1% HAuC1₄ (Aldrich, 99.9%) in water was then added to the mixture, and the mixture was stirred for another 0.5 hr. Stirring time may vary depending on the need to completely evaporate the alcohol from the sol-gel, but stirring should be done for greater than 2 hours.

2 ml of the above solution was poured into a plastic 4 ml cuvette for gelation. Here, a glass cuvette would not work in accordance with the invention due to bonding with the sol-gel. The sample was dried at 40° C. for about 24 hrs. Drying time is dependent upon the temperature used but want to achieve complete solvent evaporation from the sol-gel. At 40° C., drying time may be up to 24 hours. At room temperature, drying time may be greater than 24 hours but no more than 48 hours. If too much drying occurs, then the pores disappear. After 24 hours of drying time, the sol-gel should be monitored for overdrying. At this point a yellow gel could be separable from the cuvette.

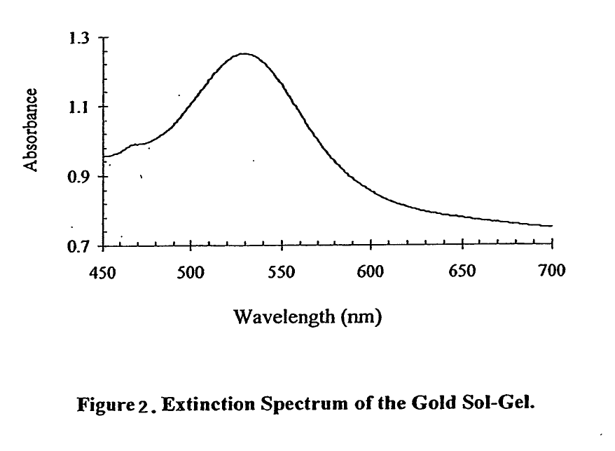

The gold, or the metal precursor, in the gel was reduced using 0.05% sodium borohydride in water . Other exemplary reducing agents may include, but are not limited to, sodium citrate and hydrogen peroxide. The reduction of the metal precursor produces these nanoparticles to be polydispersed in the sol-gel matrix. The gel was dropped into the reducing solution, when the yellow gel turned pink in color. The gel was then taken out of the solution and stored in water in a capped vial at room temperature. The ultraviolet-visible spectrum of the gel preparation was recorded using a Beckman DU 640 B and is shown in FIG. 2.

In the preparation of a silver substrate, the method is modified by using, e.g., silver nitrate (AgNO₃) and replacing the step using hydrochloric acid (HCl) with nitric acid (HNO₃). Other exemplary silver salts well known in the art may be used in the method of the present invention.

In the preparation of a platinum substrate, the method is modified by using a platinum salt such as, e.g., chloroplatinic acid (H₂PtCl₆). Other exemplary platinum salts well known in the art may be used in the method of the present invention.

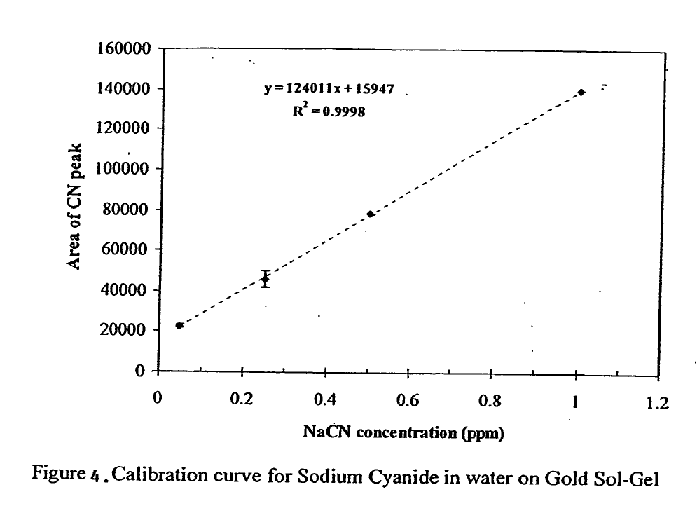

A calibration curve shown in FIG. 4 for sodium cyanide (NaCN, Aldrich, 99.99%) was constructed using 0.05, 0.25, 0.50, and 1.00 ppm concentrations. The solution of 1 ppm NaCN was prepared by diluting 1 ml of 100 ppm NaCN to 100 ml in a 100 ml volumetric flask. Other concentrations were obtained by serial dilutions. The solution of 100 ppm NaCN prepared dissolving 10 mg of NaCN in 100 ml water.

Raman spectral measurements were made using Holoprobe (Kaiser Optical systems, Inc.) Raman spectrometer equipped with 785 nm diode laser at room temperature. Low resolution SERS spectra were recorded on a Raman Systems, Inc. R-2001. For SERS spectral recording the gel was added to 0.5 ml of analyte solution in a small vial. The laser was focused onto the gel using a X-Y translation stage. The laser power at the sample was 75 mW. The spectral region of interest for cyanide, 2000-2500 cm⁻¹, was recorded using 5 sec. integration time. Background spectra of the gel in water were also recorded. Three measurements were made for each concentration.

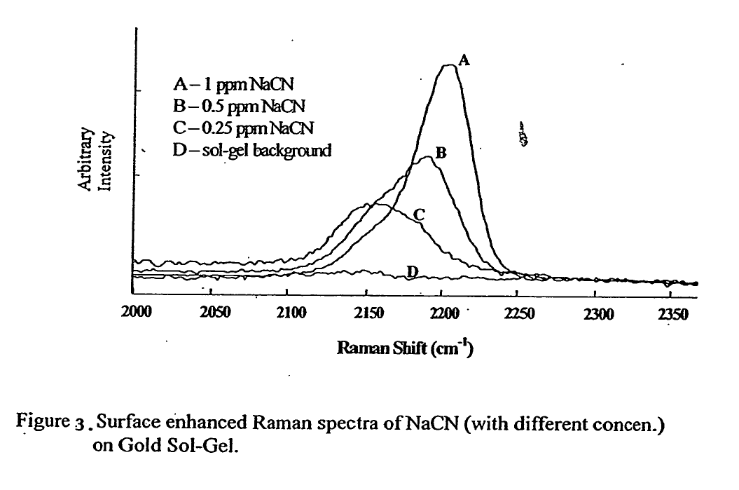

The area of cyanide peak (FIG. 3) was calculated using GRAMS 32 v5.2 (Galactic software) and is given in Table 2. The peak area was used for the y-axis of the calibration curve. The error bars indicate two standard deviations. The calibration curve is shown in FIG. 4.

TABLE 2
Area of Cyanide Peak from FIG. 3

| NaCN | | | | |
|---|---|---|---|---|
| Conc. (ppm) | Meas. 1 | Meas. 2 | Meas. 3 | Avg. |
| 1.00 | 139990 | 139835 | 139895 | 139906.70 |
| 0.50 | 78614 | 78203 | 78553 | 78456.67 |
| 0.25 | 41971 | 50464 | 45754 | 46063.00 |
| 0.05 | 23337 | 22143 | 22270 | 22583.33 |

The sol-gel without any metal colloidal particles is a glass-like transparent material. A gold colloid imbedded into the sol-gel generates a pink color. The extinction spectrum of the gold sol-gel, FIG. 2, has a characteristic peak around 530 nm. The liquid phase colloidal solution also shows the same spectrum with particle size ranging between 20-80 nm^{25,26}. Although the matrix could have an influence on the spectrum, it is postulated that the average colloidal particle size is around 60-80 nm. The colloid prepared in this way is stable for months. It also remains active and intact in different pHs, ionic strengths, and temperatures other than obvious extremes of boiling or freezing temperatures.

The SERS spectrum of cyanide is shown in FIG. 3. As seen in these spectra, two species are observed, representing two types of cyanide interactions with the gold particles in the sol-gel. One shows a peak at ˜2150 cm⁻¹ and the other at 2200 cm⁻¹. The SERS spectra show that both species are present at higher cyanide concentrations, but only one appears at a low concentration. Two types of interacting sites of cyanide with silver and/or gold are common²⁷. Therefore, the peak area better represents the relation to overall cyanide concentration.

A calibration curve was constructed using the Raman peak area. The laser at the sample was 75 MW and the integration time was 5 sec. The spot size of the laser beam when focused is 90 μm. Based on the present studies, higher laser power levels tend to degrade the intensity of the signal. This is most likely an indication of disturbance of the substrate-cyanide interaction due to local laser heating.

The slope of the curve, ˜1.2×10⁵ au/ppm (au=area unit), shows the large sensitivity of the substrate toward sodium cyanide. The limit of detection (LOD) was calculated to be about 9 ppb of cyanide ion. Furthermore, this limit was obtained using 5 sec. integration time. The signal-to-noise ratio was found to be 35 at 0.05 ppm NaCN with a single scan. Therefore, with a longer integration time, and with signal averaging (if necessary) one could lower the LOD to hundreds of parts-per-trillion. The linearity of the calibration curve shows that the technique is a powerful analytical tool in quantitative and qualitative chemical analyses.

### EXAMPLE II

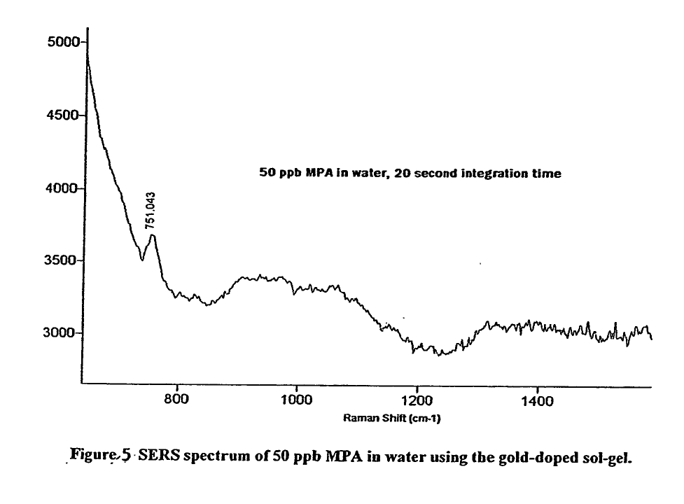

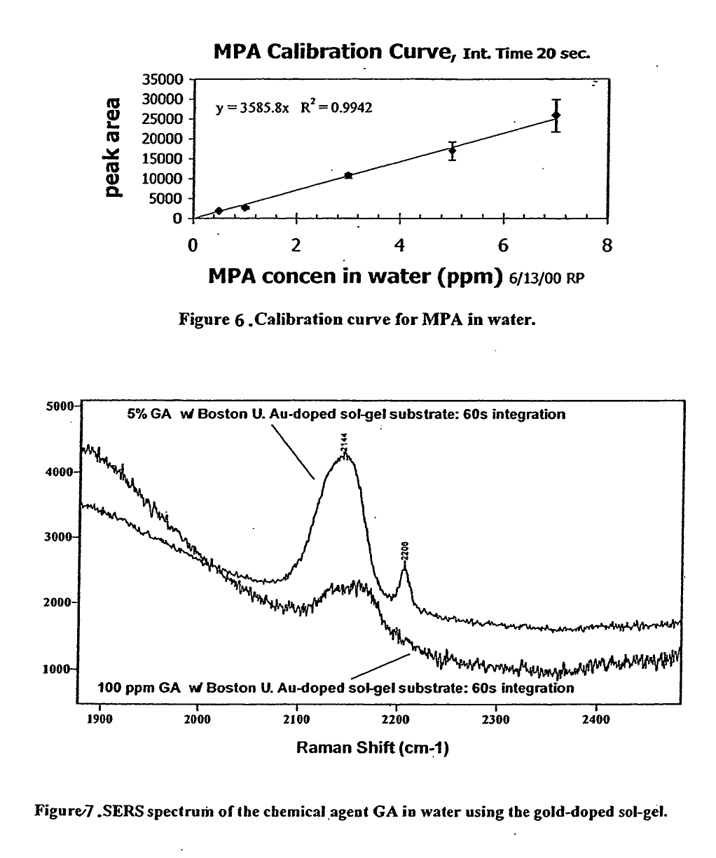

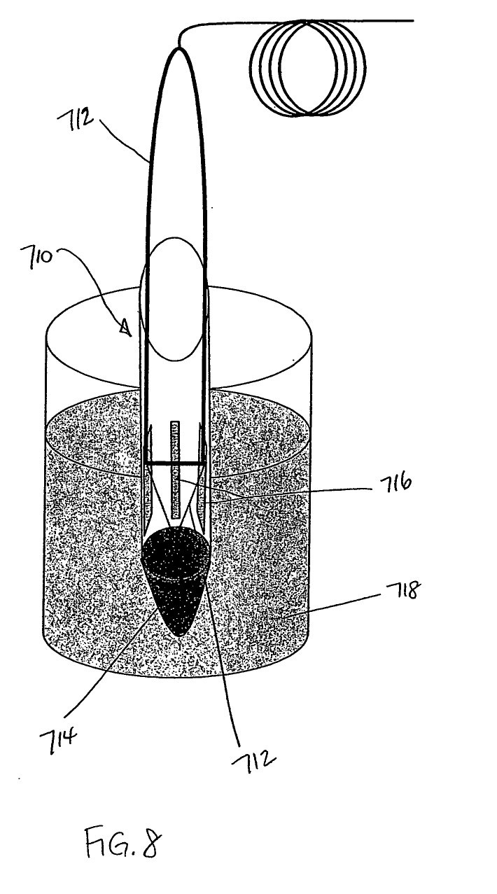

Using a fiber-optic Raman system with 785-nm diode laser excitation (manufactured by either Kaiser or EIC Laboratories, Inc.), a number of different SERS active substrates including gold colloids, gold nanostructures and sol-gels impregnated with gold and silver particles were tested. Silver-embedded sol-gels were made using similar methods as described in Example I but with a different catalytic acidic condition, e.g., with nitric acid. Of these substrates, the gold sol-gels have shown the best sensitivity for the agent stimulant methyl phosphonic acid (MPA). As shown in FIG. 5, 50 ppb (by mass) MPA in water was detected using the surface enhanced Raman spectrum with the gold sol-gel. Without the surface enhancement, MPA is not detected in water at concentrations below 1 part-per-thousand. As shown in FIG. 6, the SERS intensity is linear with concentration over the range from 500 ppb to 8000 ppb. As shown in FIG. 7, 100 ppm of GA was detected using the gold sol-gel.

### USE

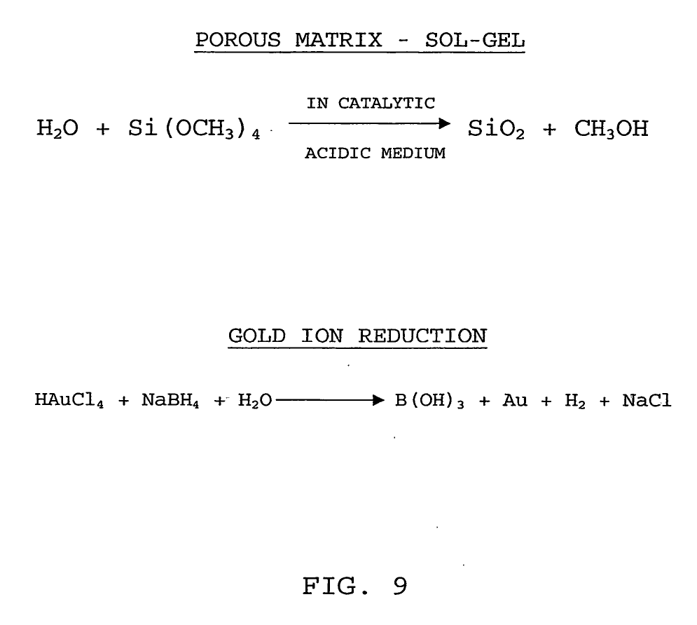

The gold embedded sol-gel substrate made in accordance with the method of the present invention with a portable Raman instrument equipped with focusable fiber optics probe and 785 nm-diode laser²⁸⁻³⁰ may be used for continuous monitoring of drinking water and wastewater. For example, as shown in FIG. 8, a support 710 has a laser source 712 that emits radiation and is applied to a metal nanoparticle-embedded sol-gel 714. The support 710 may have slits 716 to allow liquid 718 to pass through into the support 710 and contact the metal nanoparticle-embedded sol-gel 714. Scattered radiation is returned on a light guide (not shown) to an SERS detector (not shown) where wavelength detection specific to the contaminant of interest is accomplished. The support 710 may be used in any liquid area including on-site testing. The qualities of the substrate of the invention, which include disposability, stability at ambient conditions, no sample preparation, fast response time and versatility in a wide range of pH and temperatures, make its use with the SERS method a very sensitive and practical analytical tool.

The present invention provides several points of practical significance. The relative simplicity of using the sol-gel of the invention makes it versatile even for at-site or on-site analysis of water contaminants. With commercial availability of portable, battery-operated Raman systems, this approach is most suitable for field deployment and requires minimum professional expertise on the part of the user. The system could further be configured for continuous measurement, in which the concentration of the cyanide with a suitable immersion sample chamber is monitored at fixed time intervals, with supporting alarm systems, which are tripped when the concentration reaches a certain present level.

Finally, the low-resolution Raman system utilized with this invention may itself be more than is required in the ultimate SERS water contaminant detection system. The low-resolution Raman system could be further simplified by utilizing optical filters with integrated detectors, which pass only the Raman spectral regions of interest for detection of the scattered light from the sample. As an example, a filter that passes the Stokes region between 2000-2100 cm⁻¹ in the presence of 785 nm laser light as the scattering source could be used to monitor the presence of cyanide without the need for more elaborate spectral equipment.

Although simple and relatively inexpensive analysis schemes exist for, e.g., cyanide, the present invention provides a use of SERS with an improved sol-gel substrate, coupled with a lower requirement for spectral resolution, can result in a cyanide monitor of considerable flexibility. The SERS features described above are particularly significant for devices anticipated for at-site or on-site testing of water contamination by cyanide sources.

A metal, e.g., colloidal gold, encapsulated sol-gel matrix is a superior substrate for SERS work because of its sensitivity and stability in water contamination, e.g., cyanide, detection. This substrate could be utilized in detection of many other molecules and ions. Lack of sample preparation with the sol-gel substrate of the invention and the ability to use 785 nm multi-mode diode laser in, for example, cyanide measurements, the technique is easily implemented for in-situ/on-site detection and monitoring.

### REFERENCES

1. C. O. Ikebiodi, L. Wen, and L. M. Latinwo, Am. Environ. Lab., 18 (October 1997);

2. T. Akira, N. Yoshinobu, M. Norihito, S. Yuuji, I. Hidekazu, and T. Kiyoshi, Res. Rep. Inf. Sci. Electr. Eng. 5:125 (2000);

3. D. L. Recalde-Ruiz, E. Andres-Garcia and M. E. Diaz-Garcia, Quim. Anal. (Barcelona), 18(1):111 (1999);

4. N. Nakano, A. Yamamoto, Y. Kobayashi, and K. Nagashima, Anal. Chim. Acta. 398(2-3):305 (1999);

5. J. Wang, B. Tian, J. Lu, D. MacDonald, J. Wang, and D. Luo, Electroanalysis 10:1034 (1998);

6. T. M. Park, E. I. Iwuoha, and M. R. Smyth, Electroanalysis 9:1120 (1997);

7. H. Meiser, H-W. Hagedorn, and R. Schulz, Am. J. Vet. Res. 61:658 (2000);

8. M. Moskovitz, Rev. Mod. Phys. 57:783 (1985);

9. A. Otto, I. Mrozek, H. Grabhorn, and W. Akermann, J. Phys.:Condens. Matter 4:1143 (1992);

10. T. Vo-Dinh, Trends Anal. Chem. 17:557 (1998);

11. A. Campion and P. Kambhampati, Chem. Soc. Rev. 27:241 (1998);

12. S. Lecomte, P. Matejka, and M. H. Baron, Langmuir 14:4373 (1998);

13. C. J. Brinker and G. W. Scherer, The Physics and Chemistry of Sol-Gel Processing, (Academic Press, Sandiego 1990);

14. Sol-Gel Optics: Processing and Applications, L. C. Klein, (Kluwer Academic Publishers: Norwell, Mass. 1994);

15. Chemistry, Spectroscopy, and Applications of Sol-Gel glasses, R. Reisfeld, C. K. Jorgensen, (Springer-Verlag: Berlin, 1992);

16. C. M. Ingersoll and F. V. Bright, Chemtech 26 (January 1997);

17. M. A. Hayat, Colloidal Gold: Principles, Methods, and Applications, (Academic Press, 1989), vol. I;

18. W. A. Weyle, Coloured Glasses. Society of Glass Technology, (Sheffield, 1951);

19. R. W. McMillan, Glass-Ceramics, (Academic Press, London, 1964);

20. K. Fukumi, A. Chayahara, K. Kadono, T. Sakaguchi, Y. Horino, M. Miya, J. Hayakawa and M. Satou, Jpn. J. Appl. Phys. Part 2 Lett. 30:L742 (1991);

21. H. Wakabayashi, H. Yamanaka, K. Kadono, T. Sakaguchi and M. Miya, Proceedings of the International Conference on Science and Technology, S. Sakka, Eds. (1991), p. 412;

22. J. Matsuoka, R. Mizutani, H. Nasu and K. Kamiya, Nippon Seramikkusu Kyoki Gakujutsu Ronbunshi 100:599 (1992);

23. H. Kozuka and S. Sakka, Chem. Mater. 5:222 (1993);

24. M. A. Zaitoun and C. T. Lin, J. Phys. Chem. B 101:1857 (1997);

25. K. Kniepp, H. Kniepp, R. Manoharan, E. B. Hanlon, I. Itzkan, R. R. Dasari, and M. S. Feld, Appl. Spectrosc. 52:1493 (1998);

26. C. G. Blatchford, J. R. Campbell, and J. A. Creighton; Surf. Sci., 120:435 (1982);

27. Surface Enhanced Raman Scattering, R. K. Chang and T. E. Furtak, Eds. (Plenum Press, New York, 1982);

28. R. H. Clarke, S. Londhe, W. R. Premasiri, and M. E. Womble; J. Raman Spectrosc. 30:827 (1999);

29. M. E. Womble, R. H. Clarke, S. Londhe and J. P. Olafson; Laser Focus World, April (1999); and

30. J. G. Graselli and B. J. Bulkin, Analytical Raman Spectroscopy, (Wiley, New York, 1991).

While the present invention has been described in conjunction with a preferred embodiment, one of ordinary skill, after reading the foregoing specification, will be able to effect various changes, substitutions of equivalents, and other alterations to the compositions and methods set forth herein as well as other compositions with appropriate wavelengths known in the art. It is therefore intended that the protection granted by Letters Patent hereon be limited only by the definitions contained in the appended claims and equivalents thereof.

What is claimed is:

1. A metal particle glassy substrate for enhancing Raman scattering for detection of contaminants in an environment comprising:
(a) a porous matrix; and
(b) metal particles polydispersed in said matrix in sub-micron size and in a concentration to prevent conduction but to allow an increased number of contaminant particles to associate therewith so as to increase participation in light induced excited electron decay, resulting in a metal particle glassy substrate, wherein said metal particle glassy substrate enhances the intensity of Raman scattering of said contaminant particles.

2. The glassy substrate of claim 1, wherein said porous matrix is a sol-gel.

3. The glassy substrate of claim 1, wherein said metal particles are gold.

4. The glassy substrate of claim 1, wherein said metal particles are silver.

5. The glassy substrate of claim 1, wherein said metal particles are platinum.

6. The glassy substrate of claim 1, wherein said contaminant particles is selected from the group consisting of cyanide, phosphonates and thiols.

7. The glassy substrate of claim 1, wherein said metal particle glassy substrate is disposable.

8. A method of manufacture of a metal particle glassy substrate for surface enhanced Raman scattering for detection of contaminants in an environment, said method comprising the steps of:
(a) providing a sufficient amount of a metal precursor;
(b) providing a porous matrix with said metal precursor; and
(c) reducing the metal precursors in said porous matrix to produce a suspension of sub-micron size metal particles therein accessible to said environment via pores in said sol gel.

9. The method of claim 8, wherein said metal precursor is gold.

10. The method of claim 8, wherein said metal precursor is silver.

11. The method of claim 8, wherein said metal precursor is platinum.

12. The method of claim 9, wherein said gold precursor is hydrolyzed with a hydrochloric acid solution of said silane.

13. The method of claim 10, wherein said silver precursor is hydrolyzed with a nitric acid solution of said silane.

14. The method of claim 8, wherein said glassy substrate is made in a plastic molding.

15. The method of claim 8, wherein said contaminants are selected from the group consisting of cyanides, phosphonates and thiols.

16. The method of claim 8, wherein said environment is a liquid environment.

17. An apparatus for detecting contaminants in an environment comprising:
(a) a metal particle glassy substrate according to claim 1;
(b) means for exposing said glassy substrate to an environment for detection of contaminants therein; and
(c) a spectral analysis probe for emitting light to said environment in the vicinity of said glassy substrate and for receiving and analyzing light from said environment for Raman scattering characteristic of said contaminants.

18. The apparatus of claim 17, wherein said environment is liquid.

19. The apparatus of claim 17, wherein said probe is in communication with a surface enhanced Raman scattering detector.

20. The apparatus of claim 17, wherein said contaminants are selected from the group consisting of cyanide, phosphonates and thiols.

21. A method for using surface enhanced Raman scattering for detection, identification and quantification of contaminants, wherein said method comprises the steps of:
(a) preparing a metal particle glassy substrate according to claim 1;
(b) contacting said glassy substrate to an environment containing potential contaminants;
(c) exposing said glassy substrate to said environment for a time sufficient enough for detection, identification and quantification of said contaminants; and
(d) collecting and analyzing data with a data processor interfaced to a surface enhanced Raman scattering detector.

22. The method of claim 21, wherein said environment is liquid.

23. The method of claim 21, wherein said contaminants is selected from the group consisting of cyanide, phosphonates and thiols.

24. The method of claim 21, wherein step (b) further comprises contacting said glassy substrate to said environment on-site.
